(19) United States
(12) Patent Application Publication
(10) Pub. No.: US 2026/0036453 A1
(43) Pub. Date: Feb. 5, 2026

(54) MULTI-SENSOR AND RELATED ASPECTS

(71) Applicant: KONGSBERG MARITIME AS, KONGSBERG (NO)

(72) Inventor: Thomas Fossen HALLELAND, Vestfossen (NO)

(21) Appl. No.: 19/099,720

(22) PCT Filed: Jul. 19, 2023
(86) PCT No.: PCT/NO2023/060021

§ 371 Date: Jan. 29, 2025

(30) Foreign Application Priority Data
Jul. 29, 2022 (GB) 2211129.8
Jul. 29, 2022 (NO) 20220842

(51) Int. Cl. G01D 21/02; G01D 11/30; G01D 15/10; G01D 15/14; H04L 67/12; H04L 67/561; H04W 4/38; H04W 84/12; H04W 84/18

(52) U.S. Cl. CPC G01D 21/02; G01D 11/30; G01D 15/10; G01D 15/14; H04L 67/12; H04L 67/561; H04W 4/38; H04W 84/12; H04W 84/18

(57) ABSTRACT

A multi-sensor is disclosed which comprises a power supply, a surface mounting mechanism to engage with a mounting surface, a plurality of sensors with at least one being of a different sensor type than the others, each sensor to generate a raw sensor data feed responsive to sensing its environment, a sensor controller to control one or more of the sensors, one or more processors or processing circuitry to: receive a plurality of raw sensor data feeds from the plurality of sensors and process each feed to: generate sensor-specific meta-data for each feed, generate sensor-agnostic meta-data for all feeds, and generate a fused sensor data feed by at least time-fusing the sensor-agnostic meta-data and the sensor-specific meta-data with the raw sensor data feed, and a data communications component to output fused sensor feeds and receive sensor control data to control at least one of the plurality of sensors.

The present disclosure relates to a multi-sensor, an intelligent multi-sensor network, and a method of generating a plurality of multi-sensor data feeds and to related aspects.

### BACKGROUND

Networked sensor systems are well known in the art. A variety of sensors may be installed in a range of situations, such as a variety of maritime and offshore installations, public buildings and similar. Typical sensor systems include, but not limited to, sensors which are configured to monitor and/or generate alerts for a variety of use contexts from temperature and/or smoke sensors for applications such as fire detection, image sensors including CCTV systems for applications such as intruder and single occupancy monitoring. Obtaining data from such sensor systems may also require communications network components to be installed, for example, a wireless networking communication system comprising a number of different access points may be needed within a building or site to distribute Wi-Fi network cover within an installation to support such sensor systems.

Such sensor systems and their communication network support infrastructure are normally installed separately, by separate vendors, and are provided with separate human-machine interfaces. Known systems may offer some degree of capability for collaboration with a “top-system” to ease human-machine interaction (HMI) and/or automate behaviour within and across the different systems where desired by the installation owner/builder. In complex installations, the requirement for integration is typically higher, so as to allow user friendly HMI for few users/operators, despite numerous of systems applied to maintain and ensure desired functionality.

As technology matures actions previously requiring human monitoring and manual intervention are now increasingly being continuously monitored and managed using machine-based systems. However, the legacy requirements of different technologies create issues when it comes to managing the amount of infrastructure and resource requirements provided in complex installations where multiple different types of monitoring and sensing related services are required. Such installations are becoming increasingly desirable in a variety of use contexts, including but not limited to maritime and offshore installations, for example, on boats and oil-rigs, as well in on-shore installations such as in buildings and similar sites, where various sensor systems are required for monitoring environmental characteristics such as area/location, air-quality/temperature/humidity, audible characteristics such as buzzers/speakers, ambient light and motion etc.

Disadvantages of having such systems implemented independently from each other include the use of separate hardware infrastructure and service resources. For example, separate data and power cables and sources, separate and potentially conflicting computing and networking devices and components, separate servers/switches/operator interfaces, may need to be installed for each individual sensor monitoring system, which may lead to unnecessary handling, increased space, increased weight, increased power consumption and increased installation time. Another disadvantage is the potential for lack of compatible data and/or power interfaces and related functionality which limits what services may be provided using functionality which has to span different sensor systems. Whilst digital twin technology seeks to replicate sensor systems remotely and may allow multi-sensor system services to be centrally provided, however, this can require complex and potentially time-and resource hungry data processing to be performed in order for data feeds from diverse sensor systems to be merged with common time-stamps.

Accordingly, the use of separate sensor systems is challenging and may be costly in use contexts where data feeds from different sensors need to be combined. The disclosed technology seeks to mitigate, obviate, alleviate, or eliminate various issues known in the art which increase the cost of installing multi-sensor networks and/or of providing multi-sensor based technology.

### SUMMARY STATEMENTS

Whilst the invention is defined by the accompanying claims, various aspects of the disclosed technology including the claimed technology are set out in this summary section with examples of some preferred embodiments and indications of possible technical benefits.

A first aspect of the disclosed technology relates to a multi-sensor comprising a power supply, a surface mounting mechanism configured to engage with a surface on which the multi-sensor may be mounted, a plurality of sensors, at least one sensor being of a different sensor type to at least one other sensor type, each sensor being configured to generate a raw sensor data feed responsive to sensing its environment, a sensor controller configured to control one or more or all of the plurality of sensors, one or more processors or processing circuitry configured to: receive a plurality of raw sensor data feeds from each of the plurality of sensors and process each specific one of the plurality of raw sensor data feeds to: generate sensor-specific meta-data for that specific received raw sensor data feed, generate sensor-agnostic meta-data for all of the plurality of received raw sensor data feeds, and generate a fused sensor data feed by at least time-fusing the sensor-agnostic meta-data and the sensor-specific meta-data with the raw sensor data feed, and a data communications component configured to output a plurality of fused sensor feeds and receive sensor control data configuring the controller to control at least one of the plurality of sensors.

In some embodiments, the multi-sensor comprises a multi-sensor head, wherein the multi-sensor head comprises at least a plurality of sensors, at least one sensor being of a different sensor type to at least one other sensor type, each sensor being configured to generate a raw sensor data feed responsive to sensing its environment.

Advantageously, the multi-sensor is configured to use a common infrastructure for power and data which reduces the time and skills required for installation. In some use contexts, for example, if the multi-sensor is being installed in infrastructure on-board a vessel, such as a boat or submarine, an air-craft or the like, including a space-craft, or a train, the weight and bulk of cabling and wiring may accordingly be reduced. Such embodiments may allow for higher data transfer rates than a group of different sensors configured to use wireless data communications in such environments. In some embodiments, the multi-sensor is configured to flexibly engage with a surface mount via which access to power and data ports is provided, with the sensors being provided in the sensor-head component. This advantageously may reduce the time for installation and/or maintenance and future upgrades.

In some embodiments, the surface mounting mechanism comprises a housing of the multi-sensor.

Some embodiments of the multi-sensor further comprise the housing.

In some embodiments, the multi-sensor is configured to access via the housing at least one of the power supply, the sensor controller, and the data communications component.

In some embodiments, the data communications component acts as a wireless local area network, WLAN, access point, AP, and is configured to output sensor data and data received via the WLAN AP via a wired data communications link.

In some embodiments, the data communications component acts as a wireless local area network, WLAN, access point, AP, and is configured to output sensor data and data received via the WLAN AP over a wired data communications network to a data communications network gateway for onwards transmission and/or to a remote real-time controller.

In some embodiments, the sensor-agnostic meta-data generated for the different types of sensors comprises at least location and timing information.

In some embodiments, the sensor specific meta-data includes at least one of sensor identifier, a sensor type-identifier, and a network address for the sensor.

In some embodiments, each output fused data-feed comprises an encrypted fused data-feed.

In some embodiments, sensor-agnostic meta-data includes at least one of a geographic location of the multi-sensor, a multi-sensor network address and a sensor group network address.

In some embodiments, the sensor-agnostic meta-data generated for the different types of sensors comprises at least location and timing information, and wherein the sensor specific meta-data includes at least one of sensor identifier, a sensor type-identifier; and a network address for the sensor.

Some embodiments of the multi-sensor may be installed in a fixed location infrastructure such as a building or site.

In some embodiments, however, the multi-sensor is installed in a moving environment such as a marine vessel, submarine, other form of sea-going craft, an air-craft or space-craft, land-vehicle or train or the like. Reference herein to a vessel may refer to any similar moving environment unless specifically excluded by context.

In some embodiments the sensor-agnostic meta-data is dynamic meta-data, in other words, meta-data which change over time, or it may be fixed, in other words, static in some embodiments. For example, in some embodiments, sensor-agnostic data such as a geographic location of a multi-sensor is dynamic information as it changes if the infrastructure the multi-sensor is in changes, for example, if the multi-sensor is installed in a moving environment.

In some embodiments, at least one sensor comprises one of the following types of network-addressable sensor: a type of motion sensor, a type of image sensor, a type of smoke detection sensor, a type of CO2 gas detection sensor, a type of flame detection sensor and a type of heat detection sensor.

In some embodiments, thee sensor control data includes sensor operational control data for at least one of the plurality of sensors. For example, individual or multiple sensors at a multi-sensor can be remotely controlled in some embodiments and/or groups of one or more sensors, for example, of a particular type or model, located in multiple different multi-sensors can be addressed in a consistent way remotely using multicast control signals. If the multi-sensor network topology and/or individual multi-sensor locations are known, location based applications and services can be provided using the sensor agnostic location information that each multisensory provides. For example, geo-fencing type services within the infrastructure type applications can be provided using the one or more sensors to detect the movement of sensed objects/entities/users. For moving installations, for example, on-board a marine vessel, air-craft, space-craft, land-vehicle or train, where the geographic location of the multi-sensors changes, geo-fencing and other location based services can also be provided in a similar way, for example, as a vessel approaches a port, certain sensors may be activated that might not be active in order to conserve energy when the vessel is at sea.

In some embodiments, the sensor operational control data may configure sampling and/or reporting intervals for the sensor data, the metric unit to be used for the data, e.g. temperature may be reported in Celsius or degrees Fahrenheit.

In some embodiments, at least one of the plurality of sensors is individually addressable via the sensor control data as well as being associated with a group of sensors which are collectively addressable via the sensor control data.

In some embodiments, the housing is configured to reciprocally engage with the housing engagement component of the multi-sensor head and comprises at least one fixation point for attachment to a horizontal or vertical surface, and wherein the housing is configured when attached to the horizontal or vertical surface to allow the multi-sensor head to connect to at least one wired communications link and/or power supply.

Another, second, aspect of the disclosed technology comprises an intelligent multi-sensor network comprising a plurality of multi-sensors according to the first aspect, at least one multi-sensor controller, wherein the multi-sensor controller is configured to provide control data to the plurality of multi-sensors, at least one power supply configured to supply power to the plurality of multi-sensors, and at least one data gateway configured to at least route communications between the plurality of multi-sensors and the at least one controller.

In some embodiments, the network further comprises at least one client platform, wherein each client platform is configured to execute at least one application using at least a plurality of fused data feeds provided by the plurality of multi-sensors.

In some embodiments, the at least one application is an operational control application for configuring the operation of each of the plurality of multi-sensors via the control server.

In some embodiments, at least one multi-sensor comprises a fire-detection sensor which is configured to generate a fire alert, wherein the fire-detection sensor is configured to function independently of the data communications component in the multi-sensor head by at least generating an audible alert in the event it detects a fire.

Another, third, aspect of the disclosed technology comprises method of generating a plurality of multi-sensor data feeds, the method comprising at a multi-sensor: generating a plurality of different types of raw sensor data feeds, and for each one of the raw sensor data feeds: processing that raw sensor data feed to add sensor-agnostic meta-data and sensor-specific meta-data for that raw sensor data feed, generating a fused sensor data feed by time-fusing the sensor agnostic meta-data and sensor-specific meta-data with the raw sensor data feed, and outputting the fused data stream.

In some embodiments of the method aspect, the method is performed by a multi-sensor according to the first aspect or any one of its embodiment disclosed herein.

Another, fourth, aspect of the disclosed technology comprises a controller for a multi-sensor network according to the second aspect or any one of its embodiments disclosed herein, wherein the controller comprises memory, one or more processors or processing circuitry; and computer code, wherein the computer code is configured, when loaded from memory and executed by the one or more processors or processing circuitry causes the controller to generate control signals for controlling an operation of at least one sensor of at least one multi-sensor of the multi-sensor network

Another, fifth, aspect of the disclosed technology comprises a computer program product comprising computer code, wherein the computer code comprises a set of executable instructions configured, when loaded from memory and executed by one or more processors of an apparatus, cause the apparatus to perform a method according to the third aspect or any one of its embodiments disclosed herein.

Another, sixth, aspect of the disclosed technology comprises a controller for a multi-sensor according to the first aspect or any one of its embodiments disclosed herein, wherein the controller comprises memory, one or more processors or processing circuitry, and computer code, wherein the computer code is configured, when loaded from memory and executed by the one or more processors or processing circuitry causes the multi-sensor system to execute a method according to the third aspect or any one of its embodiments disclosed herein.

A computer program carrier carrying a computer program comprising computer-program code, which, when loaded from the computer program carrier and executed by one or more processors or processing circuitry of an apparatus causes the apparatus to implement a method according to the third aspect, wherein the computer program carrier is one of an electronic signal, optical signal, radio signal or computer-readable storage medium.

The disclosed aspects and embodiments may be combined with each other in any suitable manner which would be apparent to someone of ordinary skill in the art.

### BRIEF DESCRIPTION OF THE DRAWINGS

Some embodiments of the disclosed technology are described below with reference to the accompanying drawings which are by way of example only and in which:

FIGS. 1A, 1B and 1C schematically illustrate examples of known prior art fire detection, CCTV, and Wi-Fi access systems separate infrastructures;

FIG. 2 schematically illustrates an embodiment of a multi-sensor network according to some embodiments of the disclosed technology;

FIG. 3A schematically illustrates a multi-sensor and socket arrangement according to some embodiments of the disclosed technology;

FIG. 3B schematically illustrates a multi-sensor and socket arrangement according to some other embodiments of the disclosed technology;

FIG. 4 is a schematic block circuit diagram for a multi-sensor according to some embodiments of the disclosed technology;

FIG. 5 shows schematically another example of a multi-sensor network according to some embodiments of the disclosed technology for a fleet of one or more maritime vessels;

FIG. 6 shows schematically an example method of generating a plurality of multi-sensor data feeds according to some embodiments of the disclosed technology; and

FIG. 7 shows schematically an example of computer program code according to some embodiments of the disclosed technology.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Steps, whether explicitly referred to a such or if implicit, may be re-ordered or omitted if not essential to some of the disclosed embodiments. Like numbers in the drawings refer to like elements throughout.

The terminology used herein is for the purpose of describing particular aspects of the disclosure only, and is not intended to limit the disclosed technology embodiments described herein. As used herein, the singular forms “a”, “an” and “the” are intended to include the plural forms as well, unless the context clearly indicates otherwise.

Some examples of the disclosed technology relate to a multi-sensor which advantageously reduces the amount of cabling and related infrastructure resources required to deploy multiple different types of sensor systems in environments such as on-board a marine vessel or craft, sub-marine craft, air-craft, space-craft, land-craft, vehicle or train. It is advantageous in such environments in particular if the weight and/or the bulk of any cable or other network components for data and/or power can be reduced. Such environments also may be isolated from time to time and so some embodiments of the disclosed technology advantageously provide a multi-sensor system in which multi-sensor heads are replaceable by removeably engaging with a multi-sensor base. In particular, the multi-sensor may be deployed as a network providing safety monitoring applications, including monitoring for fire and similar hazard type situations. For example, motion-sensors and presence sensors which detect the presence of mobile devices such as mobile phones or other beacons which may indicate a person, may be used for mustering and similar evacuation purposes on-board vessels and the like. Such systems need to be easily maintained and repaired, or replaced, at sea where skilled persons may not be available.

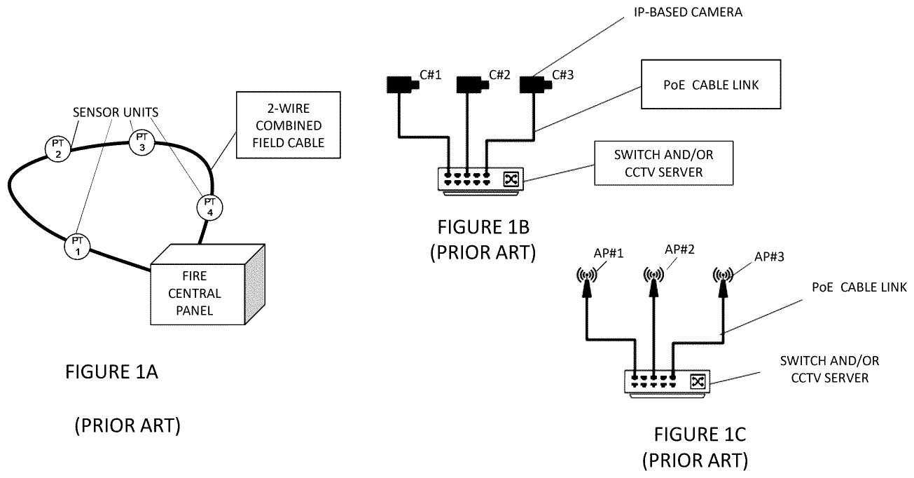

FIGS. 1A, 1B and 1C schematically illustrate how monitoring locations on sites such as those on-board a moving environment or a fixed environment, for example, on-board a vessel or building, for fire and intruders and providing wireless network coverage can involve using multiple independently configured systems each having their own separate infrastructures. FIG. 1A shows by way of example, a fire detection system such as may be commonly found on-board vessels and in buildings and similar sites. FIG. 1B shows by way of example, a closed circuit TV, CCTV monitoring system, and FIG. 1C shows an example of a Wi-Fi access network.

Each of the systems shown in FIGS. 1A to 1C may require its own dedicated infrastructure. For example, FIG. 1A shows schematically an example of a fire detection system (FDS) known in the art which is responsible for detecting fire in a building infrastructure. Typically such systems consist of a fire central panel (FCP) and sensors such as smoke, heat and manual call points connected using a loop, normally designed to carry both power and data (low bandwidth) using a 2-wire connection. As shown in FIG. 1, the various example sensor points are shown as PT1, PT2, PT3, PT4 and these are linked together via a 2-wire combined field cable loop carrying power and low bandwidth communication with a central control pane in FIG. 1. Such a system is normally installed with a dedicated infrastructure and with interface capabilities from centralized equipment. In complex installations, such a system may be regarded as an “input hub” responsible for collecting the fire detection status for individual sensors, while in an integrated automation system or safety control system, in addition logic evaluation and automated action controls, for example, activating firefighting systems, heating, ventilation and/or air conditioning, also known as HVAC, systems may be individually or collectively shutdown.

FIG. 1B shows schematically an example of a CCTV system known in the art. Such known CCTV systems are responsible for live and recorded video surveillance of a building infrastructure or other type of defined area. A CCTV system is typically delivered with Internet Protocol, IP, based cameras connected to a switch/router. Power over Ethernet (PoE) capabilities may be provided via a traditional Ethernet network. The system is normally installed with a dedicated infrastructure and with interface capabilities from centralized equipment such as a switch and/or CCTV server. As shown in FIG. 1B, there are three IP-based camera systems labelled C #1, C #2 and C #3 which are independent linked in a star-network configuration using an Ethernet with Power cable to a switch and/or CCTV server.

FIG. 1C shows schematically an example of a Wi-Fi distribution system as is known in the art. The Wi-Fi system may be typically delivered with IP based access points, connected to a switch/router with power over Ethernet (POE or UPoE) capabilities through an Ethernet network. The system is normally installed with a dedicated infrastructure and with interface capabilities from centralized equipment.

Whilst installation of separate systems may arise as a result of legacy technology, for new installations, the provision of such services by standalone systems creates several potential challenges. The systems are designed, manufactured, purchased, and installed separately and are provisioned with separate infrastructures, each systems' infrastructure having dedicated cables, power, and utilizing separate computing resources. The provision of stand-alone devices (servers/switches/operator interface etc.) increases the time and resources required to install each system shown in FIGS. 1A-1C, and it may also require increased space, weight, power consumption in addition to increased installation time.

Another issue is interoperability, particularly where applications may require functionality that spans systems and components originating and/or installed by different vendors.

In summary, if an operator wants a system that based on a fire detection (Fire Detection System), where they require the ability to visualize a position and present a set of cameras along with the fire sensors as a form of Integrated Automation System, IAS and CCTV system, they may have to pay for installation, and maintain afterwards, the two sensor systems separately. Potentially, however, this possible doubling in costs may be too costly and time-consuming to be implemented. Similar examples exist for other sensors systems, for example, adding a carbon-monoxide, CO, sensor system could potentially increase safety and security but which in reality take too long and cost too much to maintain/install.

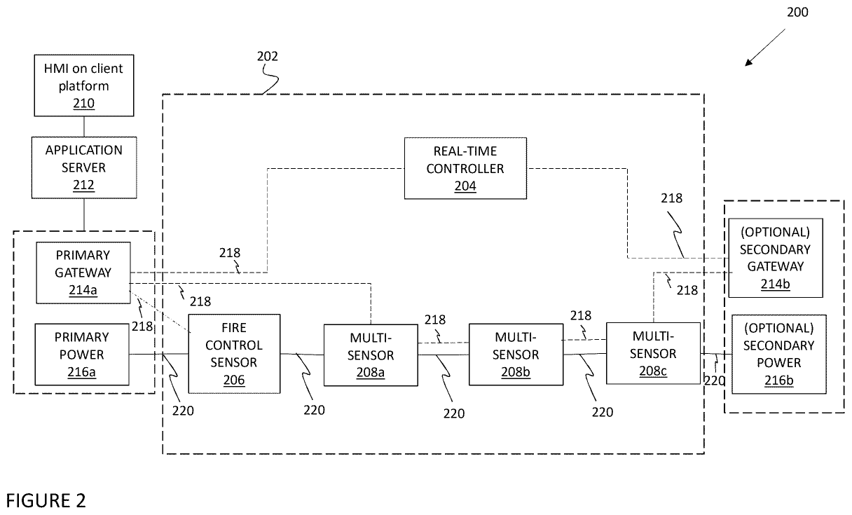

FIG. 2 shows schematically an example of a multi-sensor system 200 comprising a multi-sensor network 202 consisting of at least a real-time controller 204 and a plurality of different types of multi-sensor components 206, 208, 208a, 208b, 208c. Examples of the multi-sensor components 206, 208, 208a, 208b, 208c include a multi-sensor 206 configured to operate autonomously in the event of a fire being detected and one or more other multi-sensor units 208, 208a, 208b, 208c. The multi-sensor 206 may be configured to operate in at least one operational mode completely independently of any data services being available over wired or wireless communications link 218. This allows the multi-sensor 206 to generate an alert, for example, in the event data communications over link 218 becomes unavailable. The other multi-sensors 208, 208a, 208b, 208c comprise a number of internal sensor components or units comprising at least two different types of sensors, for example, in some embodiments an image sensor configured to detect motion may be provided along with a Bluetooth™ sensor and collectively these may be configured to detect and count how many mobile devices are in Bluetooth™ range of the sensor. Such a configuration may find utility for safety applications such as vessel or building evacuation checks etc. Such a type of multi-sensor may be provided, in an example embodiment, on-board a vessel at a vessel mustering point for vessel evacuation purposes. The same vessel however, may also be provided with other multi-sensors with a camera and motion detection sensor component which check for cabin occupancy and which include a smoke detector sensor and a temperature sensor configured to send an indication of cabin temperature by way of example.

In some embodiments, the multi-sensors include sensor components which are exchangeable or replaceable, either with the same type of sensor component or a different type of sensor component and which may, in some embodiments, be remotely re-programmable by operators. In some embodiments, the multi-sensor is configured with one or more sockets which receive reciprocally configured “plug-in” sensor components or units.

The multi-sensors 208, 208a, 208b, 208c may be all of the same identical type in some installations or alternatively be provided internally with different sensor components, e.g. different plug-in sensor components may be provided internally within one or more of the multi-sensors 208, 208a, 208b, 208c.

The multi-sensors 206, 208, 208a,208b, 208c are configured to receive control signals provided via the real-time controller 204 in FIG. 2. The data feeds which each multi-sensor generates are provided to external operators, which may be machine-systems or human, via at least one primary gateway 214a. The network topology of the multi-sensors 206, 208, 208a, 208b, 208c as shown in FIG. 2 is a loop with the multi-sensors connected in series with the primary gateway 214a for data communications. In some embodiments, as shown in FIG. 2, one or more optional secondary gateways 214b may also be provided. The fire control multi-sensor 206 and the other multi-sensors 208, 208a, 208b, 208c are all shown connected to power source 216a and they may also be connected to one or more optional secondary power sources 216b in some embodiments. The data generated by the multi-sensors 206, 208, 208a, 208b, 208c may be used to control a number of peripheral devices or systems or used in a variety of applications, for example, if the data-feed from the fire control multi-sensor 206 is indicative of a fire, a human operator may first check an image of the location of the detected fire, and if confirmed, trigger a fire alert and/or initiate a vessel evacuation plan for a vessel-based multi-sensor system.

As illustrated in FIG. 2, the data from the multi-sensors 206, 208, 208a, 208b, 208c may be provided via gate-way 214 to an application server 212, which may comprise a stand-alone platform or a cloud or networked application server in some embodiments. One or more operators may be able to control, interact, and query the multi-sensors 206, 208, 208a, 208b, 208c of the multi-sensor network 202 using a human machine interface, HMI, 210, also referred to herein as a user interface which run on a client platform, via the real-time multi-sensor network controller 204. The real-time controller 204 may be configured to control one or more or all of the operations of multi-sensors 206, 208, 208a, 208b, 208c and may be configured to provide control information to the internal controllers of each multi-sensor to individually configure the operation of one or more or all of its internal components, including its sensor components. Examples of such operations may include turning the sensors on or off, configuring the data-feeds and/or any other characteristics of the data-feeds.

As shown in FIG. 2, the multi-sensors 206, 208, 208a, 208b, 208c are connected in series, however, in some embodiments, they may be connected in a different topology configuration, for example, in a star-network configuration or loop network configuration.

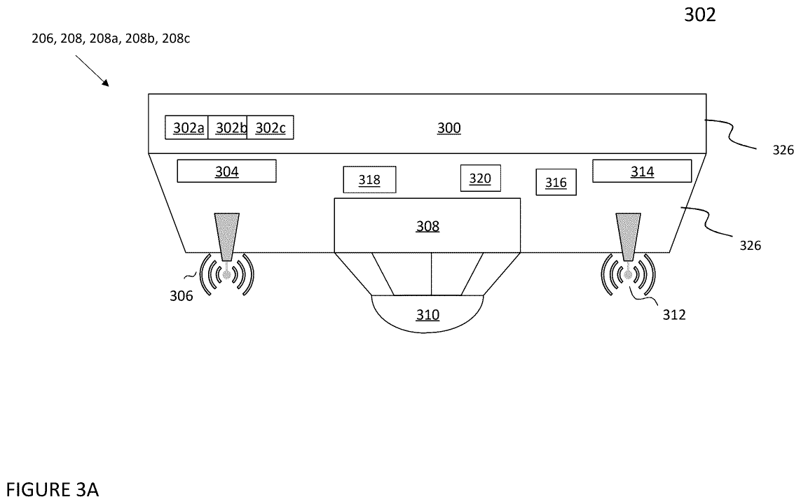

FIG. 3A shows schematically in more detail an example of a multi-sensor 206, 208, 208a, 208b, 208c according to the disclosed technology.

In some embodiments, the multi-sensor 206, 208, 208a, 208b, 208c accesses a primary power supply 216a and a primary gateway 218a for data using one or more communication and power termination ports, for example, one or more of the ports 302a,b,c of the example multi-sensor shown in FIG. 3A. As illustrated in FIG. 3A, the communication ports are provided in a surface mounting component 300 of the multi-sensor which is configured to engage with a surface on which the multi-sensor may be mounted. The ports 302a,b,c may include one or more power over Ethernet communication ports, and may provide power termination for multi-topology support (loop, star, etc.). The surface mounting component may include fixation means such as protrusions embedded integrally in a base portion 300 of a multi-sensor 206, 208, 208a, 208b, 208c, 208c.

The surface mounting component 300 may comprise a separate multi-sensor base 300 in some embodiments such as that shown in FIG. 3B described herein below. However, alternatively, in some embodiments it may be provided as an integral part of the multi-sensor body 206, 208, 208a, 208b, 208c, 208c for example, as shown in FIG. 3A, it may be provided as base component 300, alternatively the housing may be provided separately. The base 300 whether separate or integral with the multi-sensor head component 326 is in some embodiments provided with a series of apertures so that the multi-sensor can be surface mounted using separate fixing means such as pins, screws, or nails or the like. The surface mounting component(s) may, instead or in addition, comprise components formed integrally with the multi-sensor 206, 208, 208a,b,c in some embodiments. Instead or in addition, the surface mounting components may be integral to the housing for the multi-sensor in some embodiments or as another part of the multi-sensor structure. The surface mounting components may comprise or be configured to receive fixing means such as screws or nails and the like to allow the multi-sensor to be attached, for example, to a vertical or horizontal surface or even hung upside down in some embodiments. In other embodiments, however, the surface mounting component may comprise one or more regions of the multi-sensor base which can be simply glued down using a suitable adhesive glue or taped to a horizontal or vertical service. In some embodiments, the surface mounting component may simply comprise a base of the multi-sensor allowing it to be placed stably on a horizontal surface.

The multi-sensor may comprise accordingly in some embodiments a multi-sensor head 326 which includes sensor(s) and/or wireless networking access point components and a base 300. The embodiment of the multi-sensor 206, 208 shown in FIG. 3A comprises a plurality of sensors, at least one sensor being of a different sensor type to at least one other sensor type, each sensor being configured to generate a raw sensor data feed responsive to sensing its environment. Audio sensor 304 may be provided a microphone for sound detection and may be combined with a speaker or buzzer for local audio alerts. A smoke/air quality sensor 308 may be configured to sense or measure the air quality and generate air-quality data feed(s) for the air-quality around the multi-sensor 206, 208, 208a, 208b, 208c. A temperature/humidity sensor 314 may also be provided in some embodiments to measure the temperature and/or humidity around the multi-sensor and generates a temperature and/or humidity data feed. An image/motion sensor 310 such as a camera may be provided in some embodiments to generate images or video feeds of the scene around the multi-sensor 206, 208, 208a, 208b, 208c, which allows visual imagery to be provided with one or more other data feeds provided by one or more other sensors of the multi-sensor 206, 208, 208a, 208b, 208c. Not all multi-sensors 206, 208, 208a, 208b, 208c need to have their camera active all the time, and this may be configurable or triggered by motion in some embodiments. The provision of a multi-purpose camera/motion sensor 310 however allows services which would previously have been provided by CCTV to be replicated without requiring additional network infrastructure. Other applications which may be provided using the image/motion sensor 310 include video analytics of an area. For example, oil mist detections, facial recognition are two of the possible applications which may be provided when the multi-sensors 206, 208, 208a, 208b, 208c are deployed in public places with active image/motion sensors 310.

In some embodiments, wireless connectivity with external devices and systems may be provided via a Wi-Fi access point 306 and/or a Bluetooth™ sensor 312 and/or some other type of near-field communications technology, for example, radio frequency identifier data, RFID, communications may be supported in some embodiments, which may allow personnel tracking in some situations. For example, in embodiments where the multi-sensor is installed on board a vessel, the sensor 312 may be used to track crew members, and as such be very useful for emergency operations such as fire-fighting.

In some embodiments, the multi-sensor network is configured to provide public and private network coverage to support applications such as Wi-Fi distribution, support functions for remote devices and system to access the multi-sensor, for example, for users to use voice to interact with the multi-sensors and to allow collection of data from handheld devices, such as mustering data, in an unobtrusive manner by sensing the mobile phone Wi-Fi beacons when people congregate for evacuation from a vessel. Some embodiments of the multi-sensor may also include a controller 316, for example, a sensor controller 316 configured to control one or more or all of the plurality of sensors 304, 308, 310, 314 and the wireless connectivity access points 306, 312. The controller 316 may be implemented by one or more processors or processing circuity 318 of the multi-sensor executing computer program code loaded from a memory 320 in some embodiments.

In some embodiments, the sensor controller 316 or the one or more processors or processing circuitry 318 are configured to perform a method of generating a multi-sensor data stream. For example, in some embodiments, the method 600 of generating a plurality of multi-sensor data feeds described later below comprises the multi-sensor controller 316 receiving a plurality of raw sensor data feeds from each of the plurality of sensors 304, 308, 310, 314 and process each specific one of the plurality of raw sensor data feeds to generate sensor-specific meta-data for that specific received raw sensor data feed, generate sensor-agnostic meta-data for all of the plurality of received raw sensor data feeds, generate a fused sensor data feed by at least time-fusing the sensor-agnostic meta-data and the sensor-specific meta-data with the raw sensor data feed.

In some embodiments, the multi-sensor comprises data communications component configured to output a plurality of fused sensor feeds and receive control data for configuring the sensor controller 316 to control at least one of the plurality of sensors 304, 208, 208a, 208b, 208c, 310, 314.

Another embodiment of a multi-sensor is shown in FIG. 3B, where like components have retained their numbering scheme. In FIG. 3B, an example of surface mounting mechanism 322 is illustrated schematically in more detail. As shown in FIG. 3B, in some embodiments, the surface mounting mechanism may be provided as a “snap to fit” element which snaps to engage with a surface mount 324 of the multi-sensor 206, 108 300.

For example, as a flexible perimeter section of the multi-sensor which allows the multi-sensor to be snapped into a separate surface mount 324. As shown in FIG. 3B, the surface mount 324 includes no components, as a gap, groove or an aperture may be provided to allow cabling etc. to pass through the surface mount 324 to one or more communication and power termination ports 302a,302b, 302c of the multi-sensor 206, 208, 208a, 208b, 208c. It will be apparent to anyone of ordinary skill in the art that a number of the sensors may be located in the surface mount instead of in the multi-sensor head 326, depending on the level of intelligence that the system is designed to provide in the base. An advantage of embodiments which do not have any sensors in the base, is that the functionality of the multi-sensor can be upgraded and/or faulty multi-sensor units replaced in their entirety by “snapping” out the old multi-sensor head and replacing it with a new multi-sensor head.

In some embodiments of the multi-sensors 206, 208, 208a, 208b, 208c accordingly may comprise a power supply, a surface mounting mechanism configured to engage with a surface on which the multi-sensor may be mounted, a plurality of sensors, at least one sensor being of a different sensor type to at least one other sensor type, each sensor being configured to generate a raw sensor data feed responsive to sensing its environment, a sensor controller configured to control one or more or all of the plurality of sensors, one or more processors or processing circuitry configured to: receive a plurality of raw sensor data feeds from each of the plurality of sensors; and process each specific one of the plurality of raw sensor data feeds to: generate sensor-specific meta-data for that specific received raw sensor data feed, generate sensor-agnostic meta-data for all of the plurality of received raw sensor data feeds, and generate a fused sensor data feed by at least time-fusing the sensor-agnostic meta-data and the sensor-specific meta-data with the raw sensor data feed, and a data communications component configured to output a plurality of fused sensor feeds and receive control data configuring the controller to control at least one of the plurality of sensors.

In some embodiments, the multi-sensor comprises a multi-sensor head, wherein the multi-sensor head comprises at least a plurality of sensors, at least one sensor being of a different sensor type to at least one other sensor type, each sensor being configured to generate a raw sensor data feed responsive to sensing its environment. In some embodiments, the multi-sensor further comprises a housing. The surface mounting mechanism may comprise a base of the multi-sensor configured to connect via the housing to a surface such as a wall, top surface or under surface, e.g. a ceiling or support or a complete house or partial housing for the multi-sensor. In some embodiments, the multi-sensor comprises a multi-sensor head and base or housing, where the multi-sensor base or housing is configured to provide access to power and/or data ports to the multi-sensor head 206, 208, 208a, 208b, 208c. The multi-sensor head may be provided with corresponding ports to engage with and/or connect to the power and/or communication ports accessed via the base or and/or sensor housing. For example if the base or housing comprise female ports, the sensor head may be provided with a corresponding configuration of male ports to engage with the female ports for at least one of a power supply, control data from a sensor controller, and the data communications component. In some embodiments, for example, in the embodiment illustrated schematically in FIG. 3B, the multi-sensor base 324 is configured to reciprocally engage with a housing engagement component 322 of the multi-sensor. As shown in FIG. 3B, the base may be configured to be mounted on a ceiling or wall or similar surface. The multi-sensor base 324 or housing 326 may comprise at least one fixation point for attachment to a horizontal or vertical surface such as wall or ceiling. The multi-sensor base and/or housing are collectively configured so that when the multi-sensor is attached to a surface, the multi-sensor can connect to at least one wired communications link and/or power supply via communication ports 302a,b,c of which three ports are shown in the Figures merely by way of example, only. In other embodiments, depending on the network topology and cable configuration and the data and power supply requirements (for example, are back-up power and data gateways being provided) of the multi-sensor, more or fewer communication and/or power ports may be provided than those shown in FIGS. 3A and 3B.

In some embodiments, the surface mounting mechanism comprises a housing of the multi-sensor and in some embodiments, the multi-sensor head is configured to access via the housing at least one power supply, at least one sensor controller, and at least one data communications component.

In some embodiments, the multi-sensor head comprises a data communications component or port acts as a wireless local area network, WLAN, access point, AP, and is configured to output sensor data and data received via the WLAN AP via a wired data communications link. The data may be output via the sensor controller 316 of the multi-sensor in some embodiments or it may be output indirectly via a data gateway 214a,b or directly to a real-time controller 204 of a network 202 of multi-sensors in some other embodiments.

In some embodiments, the sensor-agnostic meta-data generated for the different types of sensors comprises at least location and timing information, and wherein the sensor specific meta-data includes at least one of sensor identifier, a sensor type-identifier, and a network address for the sensor. Each output fused data-feed may be individually encrypted in some embodiments or the plurality of data feeds may be collectively encrypted in some other embodiments.

In some embodiments, the sensor-agnostic meta-data includes information indicating at least one of a geographic location of the multi-sensor, a network address of the multi-sensor, and network address for the multi-sensor network 202. By providing a network address for the group of sensors 206, 208, 208a, 208b, 208c which make up the multi-sensor network 202, it is possible to multi-cast to that group of sensors. This may be useful in situations where a group of sensors collectively provide certain monitoring services. For example, on-board a vessel, each deck level may be provided with a network address for addressing control information to all of the multi-sensors on that deck level.

In some embodiments, at least one sensor comprises a network-addressable sensor and is one of the following types of sensor: a type of motion sensor, a type of image sensor, a type of smoke detection sensor, a type of CO2 gas detection sensor, a type of flame detection sensor, and a type of heat detection sensor.

In some embodiments of the multi-sensor 206, 208, 208a, 208b, 208c, the data communications component 302a is configured to receive sensor control data which configures the sensor controller to control the operation of one or more of the sensors of the multi-sensor 206, 28. In some embodiments, the sensor control data includes sensor operational control data for controlling the operation of one or more or all of the plurality of sensors 304, 308, 310, 314 and the wireless access points 306, 312. For example, this may allow in some embodiments for an individual sensor or for all of the sensors in a multi-sensor unit or part or all of a multi-sensor network to remotely turned on or off or restarted etc. Data feed characteristics may also be configured using the operational control data, for example, time intervals for capturing data, the units used in the data feeds (which may be the same or an aggregation or interpolation of the captured data units may be configured so that the data feed is generated in the right metric unit, for example, 10 degrees C. and not 10 degrees Fahrenheit.

In some embodiments, at least one of the plurality of sensors and/or wireless access points is individually addressable via the sensor control data as well as being associated with a group of sensors and/or access points which are collectively addressable via the sensor control data.

In some embodiments, the multi-sensor further comprises a housing for the multi-sensor and/or for a head part of the multi-sensor where the head part is configured to engage with a base or surface mount element. The base is configured to reciprocally engage with the housing engagement component of the multi-sensor head and comprises at least one fixation point for attachment to a horizontal or vertical surface. The base enables the housing of the multi-sensor to be attached to the horizontal or vertical surface in a way that allows the multi-sensor head to connect to at least one wired communications link and/or power supply.

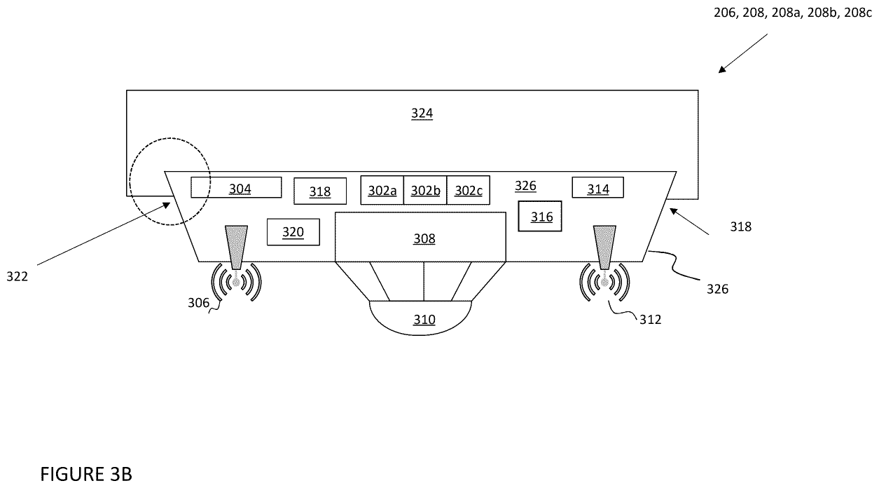

FIG. 4 shows a block diagram of an example embodiment of a multi-sensor 206, 208, 208a, 208b, 208c configured with power and data termination points to receive power via a wired connection 426 and data over a wired link 428. In the example embodiment of FIG. 4, the power and data termination points are shown as being unidirectional configured to allow the multi-sensor to be capable of being connected in series, and outgoing power and data connections 430, 432 are shown. As would be apparent to anyone of ordinary skill in the art, bidirectional communications links may be used with just a single physical connection in some embodiments. The multi-sensor may be configured with just a single power termination point to allow for star network topologies in some embodiments rather than having two connections

As shown in FIG. 4, a main controller 400 includes shared system resources such as a graphics processor 402, an internal switch 404, and memory 406 which are shared between the other system components. A number of sensor components are provided, for example, a camera unit 408, a motion sensor 410 which may be separate or integrated into the camera unit, a smoke and/or heat and/or carbon monoxide sensor 412, a temperature and/or humidity sensor 414 which when installed in the multi-sensor 206, 208, 208a, 208b, 208c are configured to automatically receive control information from the main controller 400 and to provide data feeds which are processed by the main controller 400 prior to being sent out to any remote platforms via outgoing power connection 430. In addition, a Wi-Fi access point component 416 and Bluetooth™ communications component 420 are provided.

In some embodiments, additional memory, for example, a flash memory drive for storing image data and/or other data from the sensors or other memory, for example, memory configured as random access memory, RAM, for executing computer program code may also be provided as a separate replaceable or upgradeable memory component 418. Other optional system components may include a light sensor 422 for sensing ambient light levels. A variety of other sensors may also be provided, each sensor being capable of self-identifying to the main controller 400 in some embodiments, for example, an air quality sensor for detecting volatile compounds or specific types of gas or fumes may be provided in some embodiments. In the embodiment shown in FIG. 4, a microphone 434 and speaker or buzzer 426 are also provided.

Some embodiments of the multi-sensors 206, 208, 208a, 208b, 208c may be used in an intelligent multi-sensor network to implement an integrated automation monitoring and control system (IMACS) within the infrastructure of a building or site or other defined location. Such an intelligent multi-sensor network may comprise a plurality of multi-sensors 206, 208, 208a, 208b, 208c. In some embodiments, there may be a number of multi-sensor networks which are interconnected each with their own network controller. In some embodiments, there may be a network controller configured to control the network controllers of each of the multi-sensor networks, for example, a hierarchy of networks may be implemented in some embodiments. Each network may share some or all or none of data feeds with the other networks, in other words some networks or sensor data feeds may be federated from one or more or all of the other networks or sensor data feeds in some embodiments.

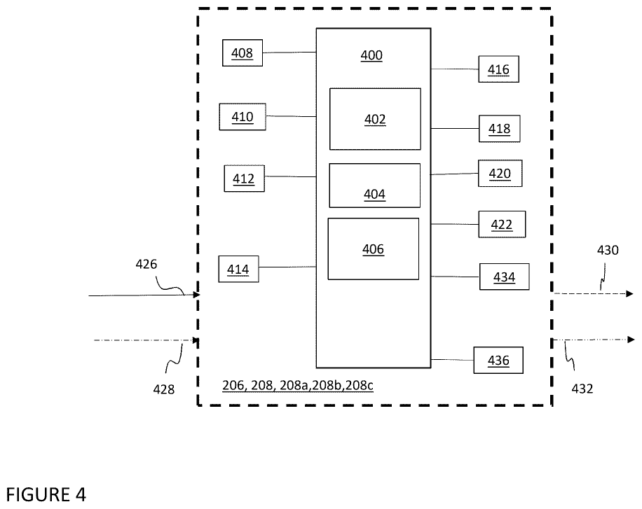

The or each intelligent multi-sensor network accordingly comprises at least one multi-sensor controller 204 such as that shown in FIG. 2 or as controller in FIG. 5 in some embodiments. The multi-sensor controller 204 is configured to provide control data to the plurality of multi-sensors 206, 208, 208a, 208b, 208c of each multi-sensor network. Each multi-sensor network also comprises at least one power supply 216 configured to supply power to the plurality of multi-sensors and at least one data gateway 214 configured to at least route communications between the plurality of multi-sensors and the at least one controller 204.

Some embodiments of the intelligent multi-sensor network include one or more client platform which is configured to execute at least one application using at least a plurality of fused data feeds provided by the plurality of multi-sensors. The at least one application may comprise an operational control application for configuring the operation of each of the plurality of multi-sensors via the control server.

To comply with any necessary regulations, when configured as an IMACS intelligent multi-sensor network, at least one multi-sensor 208, 208a, 208b, 208c, 206 comprises a fire-detection sensor 206 which is configured to generate a fire alert. The fire-detection sensor is configured to function independently of the data communications component in the multi-sensor head by at least generating an audible alert in the event it detects a fire, and may also activate a fire control mechanism(s) such as a sprinkler system in some embodiments.

FIG. 5 shows an example embodiment of such a system, for example, IMACS system 500 implemented for a plurality of vessels 502a,b,c as shown. Each vessel 502a,b,c has at least one network of multi-sensors 506, 508 which have wired connectivity on-board to one or more gateway and power sources, 504a,b,c. Each gateway/power source 504a,b,c comprises at least a primary data gateway 214a and power source 216a, and may also include one or more backup or secondary data gateways 214a or power sources 216b as shown in FIG. 2 and described herein above.

Data from each vessel is transferred wirelessly to a control network 506 comprising one or more control servers 508 allowing cloud application servers 512 forming a client or cloud network 510 to access the data feeds from one or more or all of the vessel IMAC systems 502a,b,c. At least one human machine interface may be provided for each application server 512 to allow human as well as or instead of automatic, configuration of one or more multi-sensor components, the operation of the multi-sensors and/or the configuration of operational parameters such as trigger points for actions such as generating an audible alarm or announcement, power consumption modes, reporting data feed characteristics, etc. By way of example, the IMACS system 500 may be implemented for a fleet of vessels allowing for compensatory actions by one or more vessels to off-set the sensed behaviour of another vessel. For example, any environmental issues sensed on board one vessel, may be compensated for by one or more other vessels in the fleet.

Integrated automation on monitoring & control system IAMCS applications using multiple types of sensors installed in multi-sensors according to the disclosed technology along with using real-time controllers and/or data servers allows IMACS operators to gain insights which would not be available if the multi-sensors were not able to perform edge-processing of their systems data feeds so that sensor-agnostic meta-data such as timing and location are provided in a consistent way for different types of sensors. By providing a diverse range of different types of sensor and at least data transmitters and/or receivers within each multi-sensor, consistent metadata is generated which will allow a variety of applications to be developed. For example, one or more or all of the following applications may be provided in some embodiments of such an IMACS system, including IMACS systems installed on-board a vessel:

### Enhanced Fire Detection

When an operator receives a fire alarm, the first task would normally be to confirm if there actually is a fire present. Personnel in the field would be the most trusted source, but a set of camera streams covering the area would potentially also be a secondary source to confirm whether to escalate the situation. This functionality could potentially be done without the large effort required today, hence potentially increase safety for a wider group of installations.

### Enhanced Intrusion Detection

Indoor location tracking may be achieved by technologies such as Wi-Fi, Bluetooth or RFID. By applying tracking of crew/staff, alarming can be done upon motion detection within crew/staff areas when no crew/staff member is tracked to the location. For several installations this application could potentially increase the security.

### Enhanced Cyber Security

Cyber security is an increasing concern amongst several installation types. By unifying the infrastructure there will be a less complex system to ensure and protect, and there will be also fewer interfaces between systems, believed to ease the accomplishment of higher cyber security standards.

### Virtual Presence

By combining fire detection and CCTV systems, potentially all multi-sensors mounted in “public” areas (i.e., except private cabins/rooms) may have a camera installed, increasing the overall resolution. For each multi-sensor, the user/operator may look around 360°, hear sounds, then move onto the next multi-sensor (like a hybrid of google street view and youtube360).

### Mustering/Evacuation Assistance

By utilizing the indoor personnel tracking capabilities within the multi-sensor itself, or handheld devices for manual registration/scanning, connected to the Wi-Fi access points throughout the installation—the system may act as an electronic mustering/evacuation system for keeping track of the personnel status.

### Integrated Operations

By utilizing the Wi-Fi access points ensuring 100% Wi-Fi coverage throughout the installation, a technician requesting support from a vendor may connect a headset providing video/audio connection to a system expert at the vendor, located in his/her office.

Advantageously, the common infrastructure power distribution of the network shown in FIG. 5, enables a power distribution link with capabilities of powering a series of multi-sensors, optionally from both a primary and secondary side. The power distribution comprises (or may comprise) short circuit protection at or between the multi-sensors, as well as UPS capabilities. The power distribution further comprises (or may comprise) a superimposed signal from the multi-sensors to one or more fire control panel(s) also attached to the power distribution, used as an independent/backup communication channel from the main communication link.

The common infrastructure communication/power links 218, 220 shown in FIGS. 2 and 5 which link the main or primary data gateway/power adapter 214a,216a to the networked multi-sensors 206, 208, 208a, 208b, 208c are particularly advantageous in any context where the bulk and weight of any wired connections is to be kept to a minimum, for example, on-board aircraft, vessels, trains and the like.

In some embodiments of the multi-sensor systems 200, 500, the communication links 218, 220 are connected to one or more secondary data gateway/power adapters. For example, as shown in FIG. 2 the secondary data gateway/power sources 214b, 216b provide for back-up communications and power in the event of a communication or power link break.

In some embodiments, the communication and power links comprise a set of primary (and optionally secondary) gateway/adapters. The primary and secondary data gateway/power adapters may optionally be the same physical device. The communication links may form a loop or ring topology. Examples of suitable network technologies for the data communications include but are not limited to Ethernet, Fiber optic and/or wireless communications links.

In some embodiments, the communication link may be fully encrypted.

Although the multi-sensor network shown in FIG. 2 has multi-sensors connected in series and fitted with a range of sensors as described herein, within this chapter. The multi-sensor comprises (or may comprise) several variants, for example with and without camera. The functionality and sensors listed are not complete, but indicates the main functionality intended to be covered.

The multi-sensor is typically mounted in the ceiling, and comprises (or may comprise) a socket with a “click-on” sensor unit, for example, see FIG. 3A.

Advantageously, the “click-on” embodiments, allow different types of multi-sensors to be removed and clicked back into position in a clean and fast way, allowing for future versions with improved internal components to replace existing components in a way that does not require additional wiring. This also is advantageous on board vessels, air-craft and even trains and the like as spares can be kept on board to replace any failed multi-sensor units without requiring any specialist fitting personnel or skills.

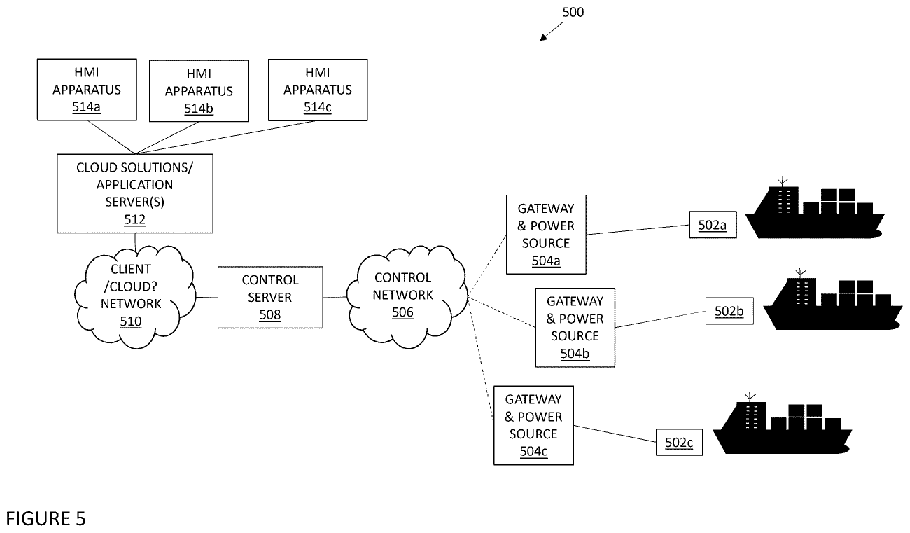

FIG. 6 of the accompanying drawings shows an example embodiment of a method of generating a plurality of multi-sensor data feeds at a multi-sensor 206, 208, 208a, 208b, 208c, according to one or more of the disclosed embodiments. As illustrated, method 600 comprises, at the multi-sensor head generating a plurality of different types of raw sensor data feeds in 602, and, for each one of the raw sensor data feeds, processing that raw sensor data feed 604 to generating meta-data 606 comprising sensor-agnostic meta-data and sensor-specific meta-data for that raw sensor data feed. The method then comprises generating in 608 a fused sensor data feed by time-fusing the sensor agnostic meta-data and sensor-specific meta-data with the raw sensor data feed. The multi-sensor 206, 208, 208a, 208b, 208c then outputs the fused data stream in 610.

In some embodiments, a controller such as a real-time controller 204 or control network server 508 controls a network of multi-sensors and comprises memory, one or more processors or processing circuitry, and computer code. The computer code is configured, when loaded from memory and executed by the one or more processors or processing circuitry to cause the controller to generate control signals for controlling an operation of one or more or all of the multi-sensors in at least one multi-sensor network.

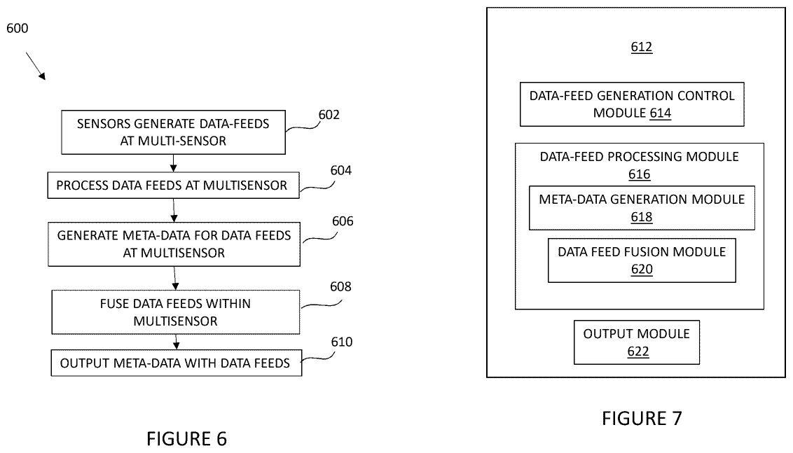

FIG. 7 illustrates schematically computer program code 612 which may be used by a controller such as the controller 316, 400 of a multi-sensor 206, 208, 208a, 208b, 208c in other words, an internal controller for sensors and components within each multi-sensor as shown schematically in FIGS. 3A, 3B and 4 to cause the multi-sensor 206, 208, 208a, 208b, 208c to implement a method such as method 600 shown in FIG. 6. In some embodiments, the controller 316, 400 includes memory, one or more processors or processing circuitry, and computer code 612 such as that shown in FIG. 7 which is configured, when loaded from memory and executed by the one or more processors or processing circuitry to cause the controller 316, 400 to generate control signals for controlling an operation of at least one sensor of at least one multi-sensor so that the multi-sensor 206 208, 208a, 208b, 208c implements an embodiment of method 600.

In FIG. 7, the computer code 612 comprises a data-feed generation module and/or circuitry 614, a data-feed processing module and/or circuitry 616 comprising a meta-data generation module and/or or circuitry 618 and a data-feed fusion module 620 along with an output module and/or circuitry 622. The meta-data generation module and/or circuitry 616 is configured to generate sensor agnostic meta-data such as, for example, location data and timing data, as well as sensor specific data. The data-feed fusion module is configured to fuse or otherwise associate the meta-data with the data feed it relates to. Meta-data may identify the sensor, the type of sensor, the metrics of the data feed and the type of metrics used, and/or provide other information relating to one or more characteristics of the data feed it relates to. The computer code 612 may be provided in a computer program product in the form of a set of executable instructions which are configured, when loaded from memory and executed by one or more processors of an apparatus, cause the apparatus to perform a method according to any one of the disclosed embodiments.

Another embodiment of the disclosed technology comprises a controller 518, 204 for a multi-sensor 206, 208, 208a, 208b, 208c. The controller comprises memory, one or more processors or processing circuitry, and computer code. The computer code is configured, when loaded from memory and executed by the one or more processors or processing circuitry to cause the multi-sensor system to execute a method according to any one of the disclosed embodiments.

Some, if not all, of the above method embodiments may be implemented using computer program code which may be provided as software or hardcoded, for example, as a computer program product.

Those skilled in the art will also appreciate that the processing circuitry and the memory or computer readable storage unit described above may refer to a combination of analog and digital circuits, and/or one or more processors configured with software and/or firmware, e.g. stored in a memory, that when executed by the one or more processors such as the processing circuitry perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

The multi-sensor controllers 316, 400 of the multi-sensors 206, 208, 208a, 208b, 208c or the real-time multi-sensor network controller 204, 508 described herein may be configured to control the data transmission between multi-sensors and any application servers in some embodiments.

The communication channels may be point-to-point, or networks, for example, over cellular or satellite networks which support wireless communications. The wireless communications may conform to one or more public or proprietary communications standards, protocols and/or technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

The computer code and/or circuitry of each multi-sensor 206, 208, 208a, 208b, 208c may include components of an operating system comprising various software components and/or drivers for controlling and components for managing general system tasks (e.g., memory management, storage device control, power management, etc.) as well as components for facilitating communication between various hardware and software components, including various sensor components, of the multi-sensors which would be apparent to anyone of ordinary skill in the art and for the sake of brevity are not further disclosed herein.

Where the disclosed technology is described with reference to drawings in the form of block diagrams and/or flowcharts, it is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

The description of the example embodiments provided herein have been presented for the purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements, features, functions, or steps than those listed and the words “a” or “an” preceding an element do not exclude the presence of a plurality of such elements, features, functions, or steps. It should further be noted that any reference signs do not limit the scope of the claims, that the example embodiments may be implemented at least in part by means of both hardware and software, and that several “means”, “units” or “devices” may be represented by the same item of hardware.

The various example embodiments described herein are described in the general context of methods, and may refer to elements, functions, steps or processes, one or more or all of which may be implemented in one aspect by a computer program product, embodied in a computer-readable medium, including computer-executable instructions, such as program code, executed by computers in networked environments.

A computer-readable medium may include removable and non-removable storage devices including, but not limited to, Read Only Memory (ROM), Random Access Memory, RAM), which may be static RAM, SRAM, or dynamic RAM, DRAM. ROM may be programmable ROM, PROM, or EPROM, erasable programmable ROM, or electrically erasable programmable ROM, EEPROM. Suitable storage components for memory may be integrated as chips into a printed circuit board or other substrate connected with one or more processors or processing modules, or provided as removable components, for example, by flash memory (also known as USB sticks), compact discs (CDs), digital versatile discs (DVD), and any other suitable forms of memory. Unless not suitable for the application at hand, memory may also be distributed over a various forms of memory and storage components, and may be provided remotely on a server or servers, such as may be provided by a cloud-based storage solution. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The memory used by any apparatus whatever its form of electronic apparatus described herein accordingly comprise any suitable device readable and/or writeable medium, examples of which include, but are not limited to: any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry. Memory may store any suitable instructions, data or information, including a computer program, software, an application including one or more of logic, rules, code, tables, etc. and/or other instructions capable of being executed by processing circuitry and, utilized by the apparatus in whatever form of electronic apparatus. Memory may be used to store any calculations made by processing circuitry and/or any data received via a user or communications or other type of data interface. In some embodiments, processing circuitry and memory are integrated. Memory may be also dispersed amongst one or more system or apparatus components. For example, memory may comprises a plurality of different memory modules, including modules located on other network nodes in some embodiments.

In the drawings and specification, there have been disclosed exemplary aspects of the disclosure. However, many variations and modifications can be made to these aspects which fall within the scope of the accompanying claims. Thus, the disclosure should be regarded as illustrative rather than restrictive in terms of supporting the claim scope which is not to be limited to the particular examples of the aspects and embodiments described above. The invention which is exemplified herein by the various aspects and embodiments described above has a scope which is defined by the following claims.

1. A multi-sensor, comprising:
a power supply;
a surface mounting component configured to allow engagement with a surface on which the multi-sensor is configured to be mounted;
a plurality of sensors, at least one sensor being of a different sensor type relative to at least one other sensor type, each sensor being configured to generate a raw sensor data feed responsive to sensing its environment;
a controller configured to control at least one or more or all of the plurality of sensors;
one or more processors or processing circuitry configured to:
receive a plurality of raw sensor data feeds from each of the plurality of sensors; and
process each specific one of the plurality of raw sensor data feeds to:
generate sensor-specific meta-data for that specific received raw sensor data feed;
generate sensor-agnostic meta-data for all of the plurality of raw sensor data feeds; and
generate a fused sensor data feed by at least time-fusing the sensor-agnostic meta-data and the sensor-specific meta-data with the raw sensor data feed; and
a data communications component configured to output a plurality of fused sensor feeds and receive sensor control data configuring the controller to control at least one of the plurality of sensors.

2. The multi-sensor of claim 1, wherein the multi-sensor comprises a multi-sensor head, wherein the multi-sensor head comprises the plurality of sensors.

3. The multi-sensor of claim 1, wherein the surface mounting component comprises or is part of a housing of the multi-sensor.

4. The multi-sensor of claim 3, wherein the housing is configured to reciprocally engage with a housing engagement component of a multi-sensor head and comprises at least one fixation point for attachment to a horizontal or vertical surface, and wherein the housing is configured when attached to the horizontal or vertical surface to allow the multi-sensor head to connect to at least one wired communications link or the power supply.

5. The multi-sensor of claim 3, further comprising a multi-sensor head is configured to access via at least one of the surface mounting component or the housing at least one of:
an external power supply;
a real-time sensor controller; and
a data communications network gateway.

6. The multi-sensor of claim 1, wherein the data communications component acts as a wireless local area network (WLAN) access point (AP), and is configured to output sensor data and data received via the WLAN AP via a wired data communications link.

7. The multi-sensor of claim 1, wherein the sensor-agnostic meta-data generated for different sensor types of the plurality of sensors comprises at least location and timing information, and wherein the sensor specific meta-data includes at least one of:
sensor identifier;
a sensor type-identifier; and
a network address for the sensor.

8. The multi-sensor of claim 1, wherein the sensor-agnostic meta-data includes at least one of:
a geographic location of the multi-sensor;
a multi-sensor network address; and
a sensor group network address.

9. The multi-sensor of claim 1, wherein one or more sensors of the plurality of sensors comprise one of the following types of network-addressable sensor:
a type of motion sensor;
a type of image sensor;
a type of smoke detection sensor;
a type of CO2 gas detection sensor;
a type of flame detection sensor; and
a type of heat detection sensor.

10. The multi-sensor of claim 1, wherein the sensor control data includes sensor operational control data for one or more of the plurality of sensors.

11. The multi-sensor of claim 10, wherein at least one of the one or more of the plurality of sensors is individually addressable via the sensor control data and is associated with a group of sensors which are collectively addressable via the sensor control data.

12. An intelligent multi-sensor network comprising:
a plurality of multi-sensors according to claim 1;
at least one real-time multi-sensor controller configured to provide control data to the plurality of multi-sensors;
at least one power supply configured to supply power to the plurality of multi-sensors; and
at least one data gateway configured to at least route communications between the plurality of multi-sensors and the at least one real-time multi-sensor controller.

13. The intelligent multi-sensor network of claim 12, further comprising at least one client platform, wherein each of the at least one client platform is configured to execute at least one application using at least a plurality of fused data feeds provided by the plurality of multi-sensors.

14. The intelligent multi-sensor network of claim 13, wherein the at least one application is an operational control application for configuring an operation of each of the plurality of multi-sensors via the at least one real-time multi-sensor controller or a control server.

15. The intelligent multi-sensor network of claim 12, wherein one or more of the plurality of multi-sensors comprises a fire-detection sensor which is configured to generate a fire alert, wherein the fire-detection sensor is configured to function independently of the data communications component by at least generating an audible alert in response to the fire-detection sensor detecting a fire.

16. A method of generating a plurality of multi-sensor data feeds, the method comprising:
at a multi-sensor:
generating a plurality of different types of raw sensor data feeds; and
for each one of the raw sensor data feeds:
processing that raw sensor data feed to add sensor-agnostic meta-data and sensor-specific meta-data for that raw sensor data feed;
generating a fused sensor data feed by time-fusing the sensor diagnostic meta-data and the sensor-specific meta-data with the raw sensor data feed; and
outputting the fused sensor data stream feed.

17. The method according to claim 16, wherein the method is performed by the multi-sensor comprising:
a power supply;
a surface mounting component configured to allow engagement with a surface on which the multi-sensor is configured to be mounted;
a plurality of sensors, at least one sensor being of a different sensor type relative to at least one other sensor type, each sensor being configured to generate a raw sensor data feed responsive to sensing its environment;
a controller configured to control at least one or more or all of the plurality of sensors;
one or more processors or processing circuitry configured to:
receive the plurality of different types of raw sensor data feeds comprising the raw sensor data feed from each of the plurality of sensors; and
perform the processing of each one of the plurality of raw sensor data feeds and the generating and outputting of the fused sensor data feed; and
a data communications component configured to output a plurality of fused sensor feeds and receive sensor control data configuring the controller to control at least one of the plurality of sensors.

18. A controller for an intelligent multi-sensor network, the intelligent multi-sensor network comprising:
a plurality of multi-sensors, each multi-sensor comprising:
a power supply;
a surface mounting component configured to allow engagement with a surface on which the multi-sensor is configured to be mounted;
a plurality of sensors, at least one sensor being of a different sensor type relative to at least one other sensor type, each sensor being configured to generate a raw sensor data feed responsive to sensing its environment;
a controller configured to control at least one or more or all of the plurality of sensors;
one or more processors or processing circuitry configured to:
receive a plurality of raw sensor data feeds from each of the plurality of sensors; and
process each specific one of the plurality of raw sensor data feeds to:
generate sensor-specific meta-data for that specific received raw sensor data feed;
generate sensor-agnostic meta-data for all of the plurality of received raw sensor data feeds; and
generate a fused sensor data feed by at least time-fusing the sensor-agnostic meta-data and the sensor-specific meta-data with the raw sensor data feed; and
a data communications component configured to output a plurality of fused sensor feeds and receive sensor control data configuring the controller to control at least one of the plurality of sensors;
the intelligent multi-sensor network further comprising:
at least one real-time multi-sensor controller configured to provide control data to the plurality of multi-sensors;
at least one power supply configured to supply power to the plurality of multi-sensors; and
at least one data gateway configured to at least route communications between the plurality of multi-sensors and the at least one real-time multi-sensor controller,
wherein the controller comprises:
memory;
one or more processors or processing circuitry; and
computer code, wherein the computer code is configured, when loaded from memory and executed by the one or more processors or processing circuitry causes the controller to generate control signals for controlling an operation of at least one sensor of at least one multi-sensor of the multi-sensor network.

19. A computer program product comprising computer code, wherein the computer code comprises a set of executable instructions configured, when loaded from memory and executed by one or more processors of an apparatus, cause the apparatus to perform he method according to claim 16.

20. A controller for a multi-sensor, wherein the controller comprises:
memory;
one or more processors or processing circuitry; and
computer code, wherein the computer code is configured, when loaded from memory and executed by the one or more processors or processing circuitry causes the multi-sensor to execute a method according to claim 16.
